(19) United States
(12) Patent Application Publication
(10) Pub. No.: US 2026/0339775 A1
(43) Pub. Date: Oct. 29, 2026

(54) EQUIPMENT MONITORING METHOD, EQUIPMENT MONITORING DEVICE AND STORAGE MEDIUM

(71) Applicant: Fulian Precision Electronics (Tianjin) Co., Ltd., Tianjin (CN)

(72) Inventors: HSIAO-WEN TSAI, New Taipei (TW); SHENG-CHUNG PAN, New Taipei (TW)

(21) Appl. No.: 19/270,732

(22) Filed: Jul. 16, 2025

(30) Foreign Application Priority Data
Apr. 24, 2025 (CN) 202510524559.2

(51) Int. Cl. G06F 11/07

(52) U.S. Cl. CPC G06F 11/0793; G06F 11/0736; G06F 11/0778; G06F 11/079

(57) ABSTRACT

An equipment monitoring method is disclosed. The method includes the following steps: obtaining operation data of the equipment; wherein the operation data comprises an event log; comparing the event log with each reference log in a reference log set to determine whether the event log is a problem log; parsing the event log through a preset analysis model to determine whether the equipment is damaged; generating solution instructions based on the event log when the equipment is in an abnormal state; controlling the equipment to execute the solution instructions. An equipment monitoring device and a non-volatile storage medium therein, for performing the above-described method, are also disclosed.

### FIELD

The present application relates to the technical field of artificial intelligence, in particular to an equipment monitoring method, an equipment monitoring device, and a storage medium.

### BACKGROUND

With the development of science and technology, equipment monitoring systems are widely used in industrial production and other fields. However, the related technology for equipment monitoring often relies on manual checking of equipment status, which requires a lot of labor and time costs to analyze the log files of the equipment, which is more demanding and prone to errors for engineers' professionalism. In addition, engineers need to log in fixed equipment to check the status of the equipment and analyze the results, and when the equipment fails, it takes a long time to analyze the components of the equipment failure and purchase them, which affects the efficiency and quality of the equipment operation.

Therefore, improvement is desired.

### BRIEF DESCRIPTION OF THE DRAWINGS

FIG. 1 is a flowchart of an equipment monitoring method according to an embodiment of the present application.

FIG. 2 is another flowchart of the equipment monitoring method according to another embodiment of the present application.

FIG. 3 is a specific flowchart of block S12 of FIG. 1.

FIG. 4 is a schematic diagram of an equipment monitoring system according to an embodiment of the present application.

### DETAILED DESCRIPTION

The technical solutions in the embodiments of the present application will be described below in conjunction with the accompanying drawings in the present application, and the embodiments described are only a portion of the embodiments of the present application, and not all of them.

With the development of science and technology, equipment monitoring systems are widely used in industrial production and other fields. However, the related technology for equipment monitoring often relies on manual checking of equipment status, which requires a lot of labor and time costs to analyze the log files of the equipment, which is more demanding and prone to errors for engineers' professionalism. In addition, engineers need to log in fixed equipment to check the status of the equipment and analyze the results, and when the equipment fails, it takes a long time to analyze the components of the equipment failure and purchase them, which affects the efficiency and quality of the equipment operation.

In order to improve the above problems, the present application provides an equipment monitoring method, an equipment monitoring device, an equipment monitoring system, and a storage medium, which can effectively improve the monitoring efficiency of the equipment.

The following explanations or definitions of the terms used in this specification are provided before explaining the specific implementation methods. The equipment monitoring device in the present application may be a terminal device provided with a mobile application, such as a computer, a cellular phone, a smartwatch, and a vehicle-mounted terminal, etc., or other devices, and the present application does not limit the specific style of the equipment monitoring device. The present application monitors the equipment, and the equipment may be a production equipment, a computer or other devices, and the present application does not limit the specific type of equipment. The equipment monitoring device in the present application monitors and manages the device through Artificial Intelligence (AI) technology, AI aims to enable machines to perform tasks that would normally require human intelligence, such as learning, reasoning, problem solving, and language understanding, the essence is to simulate human cognitive functions through algorithms and data models, and AI technology can effectively reduce labor and time costs.

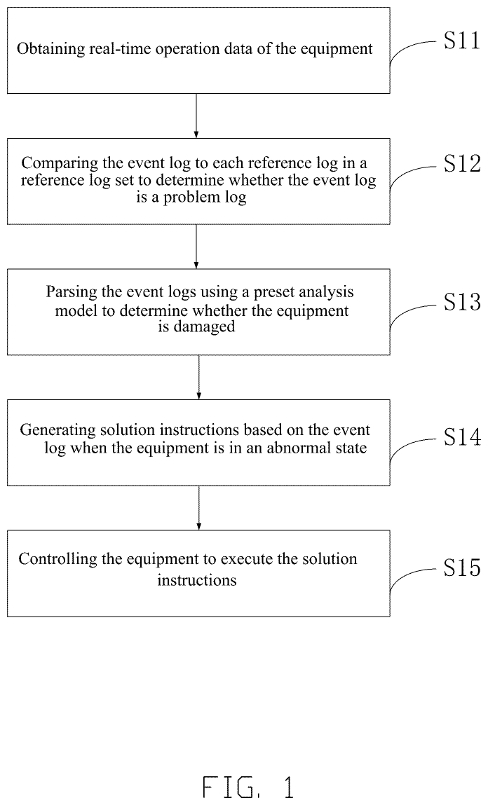

FIG. 1 is a flowchart of an equipment monitoring method in accordance with an embodiment of the present application. The equipment monitoring method is applied to an equipment monitoring device and executed by a processor of the equipment monitoring device. As shown in FIG. 1, the equipment monitoring method may include the following steps S11 to S15.

At step S11, obtaining real-time operation data of the equipment.

The operation data may include event logs. In one embodiment, the processor automatically collects all system event logs, and the event logs are record files that are regenerated by the equipment during operation, and are used to track and store events such as operations and state changes of the equipment, for example, the event logs may include the type of the event and the state of the resources of the equipment (e.g., the state of the CPU, the state of the memory, and the state of the network load) when the event occurs, etc., and the present application does not place any restrictions on the specific contents of the event logs. The present application does not restrict the specific contents of the event log.

In one embodiment of the present application, the operation data further includes equipment information. The equipment information may include server information and component information. The server information may be used to indicate state and configuration data of the equipment, for example, the server information may include performance indicators, hardware configuration, and operation system of the equipment, etc., and the present application does not limit the specific content of the server information. The equipment includes a plurality of components that work together to achieve complete operation of the equipment, for example, the components may include a switch, an uninterruptible power supply (UPS), and a smart power distribution unit (Smart PDU), etc., and may also include network-attached storage (NAS), a just a bunch of disks (JBOD), and an ambient thermometer, etc. The present application does not specify the specific components of the equipment. The component information may be used to indicate the parameters of the component at the time of operation, for example, the component information may include the model number of the component, the manufacturer, the purchase price, and the time of installation of the component, etc., and the present application does not limit the specific content of the component information. When there is damage to a component, the operation data includes the damaged component information, i.e., the component information corresponding to the damaged component. In other embodiments, the operation data may also include other data that can reflect the operation of the equipment, and the present application does not limit the operation data.

At step S12, comparing the event log to each reference log in a reference log set to determine whether the event log is a problem log.

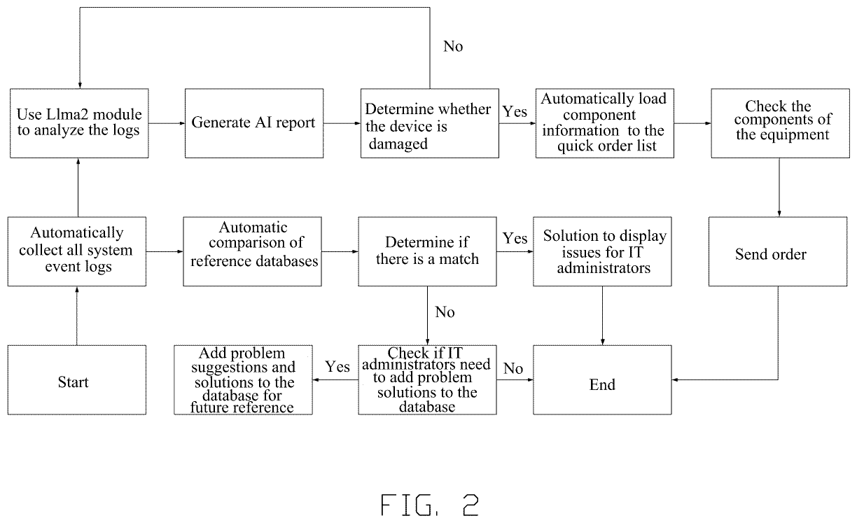

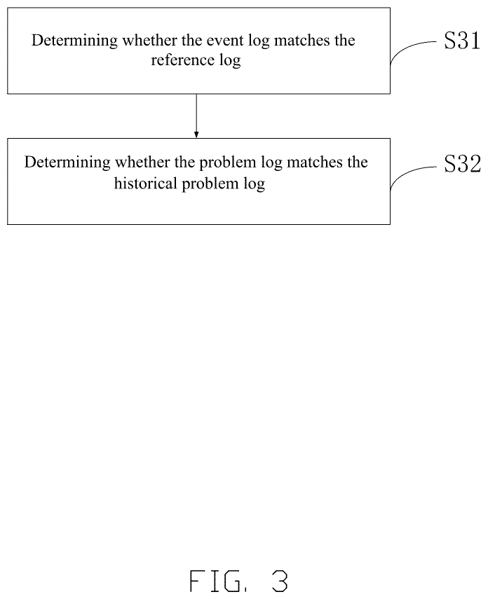

As an example, as shown in FIG. 2, a reference log set (i.e., a reference database) is pre-stored in a database, the reference log set includes a plurality of reference logs, the reference logs are log records generated when the equipment is operating in a normal state, which can provide a baseline for the analysis of the event logs, and the automated comparison of the reference databases may help to quickly identify, compare, and diagnose the captured event logs. In one embodiment, as show in FIG. 3, step S12 may include steps S31-S32 as follows.

At step S31, determining whether the event log matches the reference log.

In one embodiment, the event log may be compared with the reference log by a fuzzy matching technique, the fuzzy matching technique is a similarity-based matching method that may compare the event log with the strings in the reference log in terms of similarity, and when the degree of similarity reaches a certain level, it is confirmed that the event log and the reference log are successfully matched. The matching algorithm may include a cosine similarity algorithm, a levenshtein distance algorithm, or a Jaccard Similarity algorithm, etc., and the present application does not limit the specific matching algorithm. The present application analyzes the similarity of the keywords in the event log and the reference log by a matching algorithm, and when the analyzed similarity is within a preset similarity range, it determines that the event log matches the reference log, i.e., the equipment is running in a normal state; and when the analyzed similarity is not within the preset similarity range, it determines that the event log does not match the reference log, and that the event log is a problem log, and the equipment is in an abnormal state. The abnormal state that the equipment is damaged and/or the event log is a problem log. For example, if the similarity obtained through the matching algorithm analysis is between 0 and 1, and the preset similarity range is set to (0.45, 1), then when the similarity obtained from the actual analysis is greater than 0.45, it is determined that the event log matches the reference log, and the corresponding event is a normal event, and the equipment operates normally; when the similarity obtained from the actual analysis is less than or equal to 0.45, it is determined that the event log does not match the reference log, the corresponding event is a problem event, and the equipment is in an abnormal state. The similarity range is predetermined by those skilled in the art according to the actual situation, and the present application does not limit the specific similarity range. In other embodiments, the event logs and the reference logs may also be analyzed by other techniques capable of determining whether the contents are consistent, and the present application does not limit the specific ways of comparison.

At step S32, determining whether the problem log matches the historical problem log.

In one embodiment of the present application, when the abnormal state includes that the event log is a problem log, the problem log is matched with each historical problem log in a pre-stored historical problem log set. The historical problem log set includes a plurality of historical problem logs and corresponding repair programs. When the match is successful, the repair program corresponding to the historical problem log in the historical problem log set is retrieved. The comparison method of the problem log and the historical problem log is similar to the comparison method in step S21 and will not be repeated here.

At step S13, parsing the event logs using a preset analysis model to determine whether the equipment is damaged.

In one embodiment of the present application, the preset analysis model may be a language analysis model, such as the language models on fp16 MA lattices (Llama2), that is, the Llama2 module analysis log shown in FIG. 2. The Llama2 model is an efficient low-precision language model, its core idea is to convert high-precision floating-point operations into low-precision operations, thereby reducing the computational cost of the model. The Llama2 model uses a special matrix operation method (MA Lattices) to convert the original matrix multiplication operation into a more efficient operation method. Specifically, the Llama2 model first divides the input sequence into multiple subsequences and then processes each subsequence through a series of low-precision matrix operations. This low-precision operation not only reduces the computational complexity of the model, but also reduces the memory usage of the model. In another embodiment, the preset analysis model may also be other models that have the ability to perform analysis on the event log, and the present application does not limit the specific style of the preset analysis model. By inputting the event log into a preset analysis model, the components of the equipment may be analyzed for malfunction or damage.

In some embodiments, the preset analysis model may extract one or more participles from the event log, determine the equipment state based on the participles. Types of participles include, but are not limited to, verbs (e.g., turn or stop, etc.) and nouns (e.g., device number or location, etc.), and the present application does not limit the specific types of participles. The present application may effectively determine the real-time state of the component corresponding to the event log based on the obtained participle, for example, when “memory error” is detected, it is determined to be an error of the CPU and memory; when “TX/RX” is detected, it is determined to be a transmission error of the network module; when “Lost GPU” is detected, it is determined to be a slowdown or failure of the Graphic Processing Unit (GPU).

At step S14, generating solution instructions based on the event log when the equipment is in an abnormal state.

The abnormal state includes the event logs being at least one of the problem logs and device damage. The reasons why problem logs appear during equipment use include but are not limited to application crashes, registry errors, or network errors, the present application does not limit the specific reasons for the problem logs. The solution instructions include at least one of a repair procedure and an order.

In one embodiment of the present application, when the abnormal state includes that the event log is a problem log, the problem log is matched with the historical problem log according to step S12, and the generated solution instructions include a repair program. When the match is successful, the repair program of the historical problem log corresponding to the problem log is directly called. When the match is unsuccessful, a first prompt message is generated to prompt the user to process the problem log, and a repair program for the user to process the problem log is obtained in real time; when the problem log is processed, a second prompt message is generated to determine whether the problem log and the corresponding repair program are added to the historical problem log set, to check whether the IT administrator needs to add the problem solution to the database. When the problem log and the corresponding repair program are added to the historical problem log set, the historical problem log set is updated, when the event log is determined to be a problem log again, the updated historical problem log set is retrieved, and the problem suggestions and solutions are added to the database for future reference. For example, the historical problem log set is A={(A₁, a₁), (A₂, a₂), (A₃, a₃)}, A₁ is the first historical problem log, a₁ is the repair program for the first historical problem log; A₂ is the second historical problem log, a₂ is the repair program for the second historical problem log; A₃ is the third historical problem log, a₃ is the repair program for the third historical problem log. If the problem log does not match the historical problem logs A₁, A₂ and A₃, the problem log is added into the historical problem log set as the fourth historical problem log and the updated historical problem log A′={(A₁, a₁), (A₂, a₂), (A₃, a₃), (A₄, a₄)} is obtained, and when the problem log is determined again, the updated historical problem log A′ is used as a baseline.

In one embodiment of the present application, when the abnormal state includes equipment damage, the damaged component information is obtained, and the order is generated based on the damaged component information. Users may learn about the specific component information that need to be replaced based on the order. The order content includes but is not limited to the component model and component quantity, the present application does not limit the order content.

At step S15, controlling the equipment to execute the solution instructions.

The processor of the equipment monitoring device sends signals to the components of the equipment according to the generated solution instructions, and the components of the equipment operate according to the received signals, so that the normal operation of the equipment may be guaranteed.

In some embodiments, the equipment monitoring device further comprises a display module, the display module may be integrated into the equipment monitoring device or may be a separately set up display, the present application does not limit the specific way of setting the display module. For example, the equipment monitoring device is displayed to the user through the application software of the cell phone, and the user can obtain the state data of all components of the equipment, the log analysis report obtained after analyzing the equipment (i.e., generating the AI report in FIG. 2), and the order page (i.e., automatically loading the component information to the quick-order list in FIG. 2), etc., and the user can obtain the log analysis report of the corresponding component by clicking on each component. The user can click on each component to obtain the log analysis report of the corresponding component, and the present application does not limit the specific display contents of the display module. In one embodiment, when the solution instructions include an order, the display module displays the content of the order to the user, and when the user checks whether the quantity of the spare component is sufficient to replace the damaged component (i.e., checking the equipment component in FIG. 2), if purchase is required, the equipment monitoring device may quickly place an order after confirming the order and send an email to the relevant user responsible for the purchase, so that the user can follow up on the purchase matters in a timely manner, so that the equipment may quickly replace the damaged components, reduce the time the equipment is down, and improve the work efficiency of the equipment.

In one embodiment of the present application, the equipment monitoring device may also determine the severity of the problem log and provide preliminary processing suggestions to the user based on the severity. In the present application, a decision tree type model (such as a random forest or gradient boosting tree, etc.), a neural network-based importance model, or a linear regression-based importance model may be used to determine the severity of the problem log, or other models capable of determining the severity may be used, and the present application does not impose any limitation on the specific model used to determine the severity. The display module may sort and display the judgment results from high to low severity, and generate suggestion prompts for the user according to the solution instructions. For example, when two components are detected in the problem log, the first one is GPU slowdown detected, and the second one is Self-Monitoring, Analysis and Reporting Technology (SMART) error detected on disk, if the severity of GPU slowdown is higher than SMART error on disk, then after analyzing and processing, the display module will display “GPU slowdown detected, it is recommended to check the cooling module or driver version” in priority, and then display “SMART error on disk, please consider to do it”. If the severity of GPU slowdown is determined to be higher than the SMART error of the disk, then after analyzing and processing, the display module will give priority to displaying “GPU slowdown detected, it is recommended to check the heat dissipation module or the driver version”, and then displaying “SMART error of the disk, please consider backing up the data and replacing the disk”. when an abnormal state of the equipment, the display module may be based on the results of the analysis (i.e., such as FIG. 2 for IT administrators to display the problem solution), in a clear way to show the specific problem log component name and problem type and other information, so that users may quickly access the status of the equipment, to understand the specific location of the equipment anomalies, to improve the stability of the operation of the equipment, and improve the monitoring efficiency of the of the equipment.

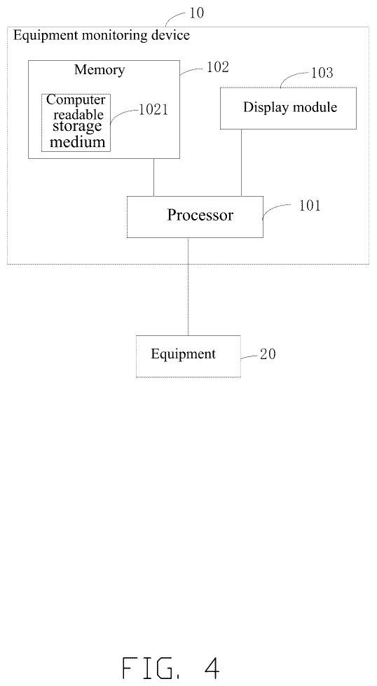

Referring to FIG. 4, in some embodiments, the present application provides an equipment monitoring device 10, the equipment monitoring device 10 is used to monitor the equipment 20, the equipment monitoring device 10 includes at least one processor 101 and a memory 102 communicatively coupled to the at least one processor 101. The memory 102 stores instructions that may be executed by at least one processor 101, so that at least one processor 101 may execute the equipment monitoring method described in any of the above embodiments.

The memory 102 and the processor 101 are connected by a bus, the bus may include any number of interconnected buses and bridges. The bus connects various circuits of one or more processors 101 and memory 102 together. The bus may also connect various other circuits such as peripheral devices, voltage regulators, and power management circuits together, which are well known in this field. The bus interface provides an interface between the bus and the transceiver. A transceiver may be a single component or multiple components, such as multiple receivers and transmitters, providing a unit for communicating with various other devices over a transmission medium. The data processed by processor 101 is transmitted over a wireless medium through an antenna, the antenna receives the data and transfers it to the memory 102. The processor 101 is responsible for managing the bus and general processing, and may also provide various functions including timing, peripheral interfaces, voltage regulation, power management, and other control functions, and the memory 102 may be used to store the data used by the processor 101 when performing operations.

In one embodiment of the present application, the equipment monitoring device 10 establishes a communication connection with the equipment 20. The communication connection includes a wired communication connection and/or a wireless communication connection. The wired communication connection includes, but is not limited to, wired communication based on RS485 bus, wired communication based on Universal Serial Bus (USB), or wired communication based on Industrial Ethernet technology, and the wireless communication connection includes, but is not limited to, Bluetooth, Wi-Fi, or ZigBee, and the present application does not place any limitations on the specific manner of the communication.

In one embodiment of the present application, as shown in FIG. 4, the equipment monitoring device 10 further includes a display module 103, the display module 103 is connected to the processor 101, and the display module 103 is used for displaying the operation data of the equipment 20 and the analysis results of the processor. The display module 103 may be integrated on the equipment monitoring device 10, for example, the equipment monitoring device 10 is integrated on a user terminal such as a cell phone or a computer, which may display the content to the user directly through the application software on the display; or it may be separately set up and establish a communication connection with the processor 101, the communication connection including a wired communication connection and/or a wireless communication connection, for example, the display module 103 may be a large center control screen or a projection, etc. The present application does not limit the specific realization of the display module 103.

Referring to FIG. 4, the present application also provides an equipment monitoring system 1, the equipment monitoring system 1 includes an equipment 20 and an equipment monitoring device 10 as described in any one of the above embodiments. The equipment 20 is monitored by the equipment monitoring device 10, so that the equipment monitoring device 10 is capable of quickly determining the root cause of a problem when the equipment 20 is in an abnormal state, reduces the cost of analyzing the problem and repairing the problem, reduces the experience requirement of an operating user, improves the efficiency and accuracy of data analysis, and ensures the stable operation of the equipment 20.

Referring to FIG. 4, the present application also provides a computer readable storage medium 1021 storing a computer program, the computer program being executed by the processor 101 to implement an equipment monitoring method as described in any of the above embodiments. The computer program may be in the form of source code, in the form of object code, in the form of an executable file, or in some intermediate form, etc. The computer readable storage medium may include: any entity or device capable of carrying computer program code, recording media, USB flash drives, removable hard disks, magnetic disks, optical disks, computer memories, read-only memories (ROM), random access memories (RAM), electric carrier signals, telecommunication signals, and Software distribution media, etc.

Those of ordinary skill in the art should realize that the above embodiments are only used to illustrate the present application, but not to limit the present application. As long as they are within the essential spirit of the present application, the above embodiments are appropriately made and changes fall within the scope of protection of the present application.

What is claimed is:

1. An equipment monitoring method configured for monitoring an equipment, the equipment monitoring method comprising:
obtaining operation data of the equipment; wherein the operation data comprises an event log; and
comparing the event log with each reference log in a reference log set to determine whether the event log is a problem log;
parsing the event log through a preset analysis model to determine whether the equipment is damaged;
generating solution instructions based on the event log when the equipment is in an abnormal state; wherein the abnormal state comprises at least one of the event log being a problem log and the equipment being damaged; and
controlling the equipment to execute the solution instructions.

2. The equipment monitoring method of claim 1, wherein the operation data further comprises damaged component information, the solution instructions comprise an order; wherein generating solution instructions based on the event log when the equipment is in an abnormal state, comprises:
obtaining the damaged component information when the abnormal state includes the equipment being damaged; and
generating the order based on the damaged component information.

3. The equipment monitoring method of claim 1, wherein the solution instructions include a repair program, wherein generating solution instructions based on the event log when the equipment is in an abnormal state, comprises:
matching the problem log with each historical problem log in a historical problem log set when the abnormal state includes the event log being the problem log,
retrieving the repair programs corresponding to the historical problem log from the historical problem log set when the matching is successful.

4. The equipment monitoring method of claim 3, further comprising:
generating a first prompt message to prompt a user to process the problem log and obtaining the repair program when the user processes the problem log when the matching is unsuccessful.

5. The equipment monitoring method of claim 4, further comprising:
generating a second prompt message to determine whether the problem log and corresponding repair program have been added to the historical problem log set after the problem log is processed.

6. The equipment monitoring method of claim 5, further comprising:
updating the historical problem log set based on the problem log and added repair program after the repair program is added.

7. An equipment monitoring device configured for monitoring an equipment, and comprising:
a storage device; and
at least one processor, wherein the storage device stores one or more instructions, when executed by the at least one processor, the one or more instructions cause the at least one processor to:
obtain operation data of the equipment; wherein the operation data comprises an event log; and
compare the event log with each reference log in a reference log set to determine whether the event log is a problem log;
parse the event log through a preset analysis model to determine whether the equipment is damaged;
generate solution instructions based on the event log when the equipment is in an abnormal state; wherein the abnormal state comprises at least one of the event log being a problem log and the equipment being damaged; and
control the equipment to execute the solution instructions.

8. The equipment monitoring device of claim 7, wherein the at least one processor is further caused to:
obtain a damaged component information when the abnormal state includes the equipment being damaged; and
generating an order based on the damaged component information.

9. The equipment monitoring device of claim 7, wherein the at least one processor is further caused to:
match the problem log with each historical problem log in a historical problem log set when the abnormal state includes the event log being the problem log,
retrieve a repair program corresponding to the historical problem log from the historical problem log set when the matching is successful.

10. The equipment monitoring device of claim 9, wherein the at least one processor is further caused to:
generate a first prompt message to prompt a user to process the problem log and obtain the repair program when the user processes the problem log when the matching is unsuccessful.

11. The equipment monitoring device of claim 10, wherein the at least one processor is further caused to:
generate a second prompt message to determine whether the problem log and corresponding repair program have been added to the historical problem log set after the problem log is processed.

12. The equipment monitoring device of claim 11, wherein the at least one processor is further caused to:
update the historical problem log set based on the problem log and added repair program after the repair program is added.

13. A non-transitory storage medium having stored thereon instructions that, when executed by a processor of an equipment monitoring device, causes the processor to perform an equipment monitoring method, wherein the method comprises:
obtaining operation data of the equipment; wherein the operation data comprises an event log; and
comparing the event log with each reference log in a reference log set to determine whether the event log is a problem log;
parsing the event log through a preset analysis model to determine whether the equipment is damaged;
generating solution instructions based on the event log when the equipment is in an abnormal state; wherein the abnormal state comprises at least one of the event log being a problem log and the equipment being damaged; and
controlling the equipment to execute the solution instructions.

14. The non-transitory storage medium of claim 13, wherein the operation data further comprises damaged component information, the solution instructions comprise an order; wherein generating solution instructions based on the event log when the equipment is in an abnormal state, comprises:
obtaining the damaged component information when the abnormal state includes the equipment being damaged; and
generating the order based on the damaged component information.

15. The non-transitory storage medium of claim 13, wherein the solution instructions include a repair program, wherein generating solution instructions based on the event log when the equipment is in an abnormal state, comprises:
matching the problem log with each historical problem log in a historical problem log set when the abnormal state includes the event log being the problem log,
retrieving the repair programs corresponding to the historical problem log from the historical problem log set when the matching is successful.

16. The non-transitory storage medium of claim 15, further comprising:
generating a first prompt message to prompt a user to process the problem log and obtaining the repair program when the user processes the problem log when the matching is unsuccessful.

17. The non-transitory storage medium of claim 16, further comprising:
generating a second prompt message to determine whether the problem log and corresponding repair program have been added to the historical problem log set after the problem log is processed.

18. The non-transitory storage medium of claim 17, further comprising:
updating the historical problem log set based on the problem log and added repair program after the repair program is added.
